(19) United States
(12) Patent Application Publication
(10) Pub. No.: US 2003/0185198 A1
(43) Pub. Date: Oct. 2, 2003

(54) Transmission control method, server apparatus and mobile terminal device

(75) Inventors: Masahiro Ishiyama, Kanagawa-ken (JP); Tatuya Jinmei, Kanagawa-ken (JP); Yuzo Tamada, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/393,940

(22) Filed: Mar. 24, 2003

(30) Foreign Application Priority Data
Mar. 29, 2002 (JP) 2002-097763

(51) Int. Cl. H04L 12/56

(52) U.S. Cl. 370/351; 370/389

(57) ABSTRACT

A server apparatus capable of concealing the present location of a mobile terminal in Mobile IPv6 is to be provided. A server assigns an address for location concealment to be used as a pseudo care-of address to a mobile terminal to conceal a care-of address acquired at its present location. The mobile terminal creates and sends an encapsulated packet in which an IP packet containing the acquired address for location concealment as a source address, the address of a correspondent terminal as a determination address and its own home address is encapsulated where its care-of address is a source address and the address of the server is a determination address. The server decapsulates the received encapsulated packet, extracts the IP packet, and sends the extracted IP packet. The IP packet is received by the correspondent terminal.

### BACKGROUND OF THE INVENTION

1. Field of the Invention

The present invention relates to a transmission control method, a server apparatus, and a mobile terminal device for providing the privacy of an identifier and a present location of a mobile node in the case of utilizing Mobile IPv6 protocols securing the migration transparency on IPv6.

2. Description of the Related Art

In recent years, the world's largest computer network, the Internet, has been widely used. New computer businesses have been developed by connecting the Internet to utilize information open to public inspection and services or by providing information and services to external users having access through the Internet. In addition, new technical development and deployment have been made on utilizing the Internet

In the Internet, each terminal has an identifier called IP address, and packets are switched based on the IP address. However, the IP address actually serves not only as the terminal identifier but also as a location identifier of networks. On this account, when the terminal moves its location on the networks, a calculator after the move and a calculator before the move are considered to be different calculators on the networks even though they are the same calculator in the real world.

However, in the widespread use of portable terminals (calculators and other devices) these days, it becomes inconvenient when the terminal is handled as a different terminal at every move. For example, authentication based on the IP address is not operated at the intention of an administrator, or the move causes an active session to discontinue.

In order to avoid the problems, IETF (Internet Engineering Task Force), the Standardization Conference for. IP, has been considering Mobile IPv6 for assuring the migration transparency in IPv6. Mobile IPv6 is the system that a mobile terminal is independent of the locations of the networks and it continues to use a certain unique IP address (it is called home address). The mobile terminal adds information about its home address in an IP packet sent by the mobile terminal, and thus its home address is sent to a communication destination. When a receiver of the packet sends a packet to the mobile terminal, the receiver sends the packet where the home address is the end point. Furthermore, when the receiver knows the present location of the mobile terminal, the receiver sends a packet where the present location is a transfer point.

Accordingly, the use of the Mobile IPv6 keeps the migration security, and thus the session is not interrupted even though the terminal moves around on the networks. However, its own ID (home address) is inevitably sent to the receiver, and thus the privacy of the mobile terminal is not kept. In communications with an unspecified number of people, the privacy is likely to be known. In addition to this, in Mobile IPv6, its present location on the networks is always embedded in a source address of the packet. Therefore, it is also difficult to conceal the present location, and thus the privacy is also likely to be known in the communications with an unspecified number of people.

### SUMMARY OF THE INVENTION

As described above, the existing Mobile IPv6 cannot keep the privacy of the mobile terminal, and the privacy is likely to be known in the communications with an unspecified number of people. Moreover, it is also difficult to conceal the present location, and thus the privacy is also likely to be known in the communications with an unspecified number of people.

The invention has been made in consideration of the circumstances. The object is to provide a transmission control method, a server apparatus and a mobile terminal device capable of concealing the present location and the identifier of the mobile terminal in Mobile IPv6.

The invention is a transmission control method of a server apparatus for providing a service to a mobile terminal device allowing packet transfer processing according to Mobile IPv6 protocols, the service to conceal a care-of address acquired by the mobile terminal device at its present location, the method characterized by having:

assigning an address for location concealment to be used as a pseudo care-of address to the mobile terminal device;

receiving an encapsulated packet from the mobile terminal device in which an IP packet containing the address for location concealment of the mobile terminal device as a source address, an address of a correspondent terminal as a determination address and a home address of the mobile terminal device is encapsulated where the care-of address of the mobile terminal device is a source address and an address of the server apparatus is a determination address;

decapsulating the received encapsulated packet to extract the IP packet; and

sending the extracted IP packet.

In addition, the invention is a transmission control method of a server apparatus for providing a service to a mobile terminal device allowing packet transfer processing according to Mobile IPv6 protocols, the service to conceal a home address actually held by the mobile terminal device, the method characterized by having:

assigning an address for identifier concealment to be used as a pseudo home address to the mobile terminal device;

receiving an IP packet from a correspondent terminal of the mobile terminal device in which an address of the correspondent terminal is a source address and the address for identifier concealment of the mobile terminal device is a determination address;

creating an encapsulated packet in which the received IP packet is encapsulated where an address of the server apparatus is a source address and a care-of address or the actual home address of the mobile terminal device is a determination address; and

sending the created encapsulated packet.

Furthermore, the invention is a transmission control method of a home agent apparatus disposed in a home network of a mobile terminal device allowing packet transfer processing according to Mobile IPv6 protocols, the method characterized by having:

receiving an encapsulated packet from a predetermined server apparatus in which an IP packet where an address of a correspondent terminal of the mobile terminal device is a source address and a predetermined address of the mobile terminal device is a determination address is encapsulated where the predetermined server apparatus is a source address and a home address of the mobile terminal device is a determination address;

decapsulating the received encapsulated packet to extract the IP packet;

creating an encapsulated packet in which the extracted IP packet is encapsulated where an address of the home agent apparatus is a source address and a care-of address of the mobile terminal device is a determination address; and

sending the created encapsulated packet.

Moreover, the invention is a transmission control method of a terminal device allowing packet transfer processing according to Mobile IPv6 protocols, the method characterized by having:

acquiring an address for location concealment to be used as a pseudo care-of address from a server apparatus for providing a service to conceal a care-of address acquired by the mobile terminal device at its present location;

creating an encapsulated packet in which an IP packet containing the acquired address for location concealment as a source address, an address of a correspondent terminal as a determination address and an actual home address of the mobile terminal device is encapsulated where the care-of address of the mobile terminal device is a source address and an address of the server apparatus is a determination address; and

sending the created encapsulated packet.

Besides, the invention is a transmission control method of a mobile terminal device allowing packet transfer processing according to Mobile IPv6 protocols, the method characterized by having:

acquiring an address for location concealment to be used as a pseudo care-of address from a first server apparatus for providing a service to conceal a care-of address acquired by the mobile terminal device at its present location and acquiring an address for identifier concealment to be used as a pseudo home address from a second server apparatus for providing a service to conceal a home address actually held by the mobile terminal device;

creating an encapsulated packet in which an IP packet containing the acquired address for location concealment as a source address, an address of a correspondent terminal as a determination address and the address for identifier concealment as the home address of the mobile terminal device is encapsulated where an actual care-of address of the mobile terminal device is a source address and an address of the first server apparatus is a determination address; and

sending the created encapsulated packet.

In addition, the invention is a transmission control method of a mobile terminal device allowing packet transfer processing according to Mobile IPv6 protocols, the method characterized by having:

acquiring an address for identifier concealment to be used as a pseudo home address from a server apparatus for providing a service to conceal a home address actually held by the mobile terminal device;

creating an IP packet containing a care-of address acquired by the mobile terminal device at its present location as a source address, an address of a correspondent terminal as a determination address and the address for identifier concealment as the home address of the mobile terminal device; and

sending the created IP packet.

Furthermore, the invention in the apparatus is realized as the invention in a method, and the invention in the method is realized as the invention in the apparatus. Moreover, the invention in the apparatus or the method is also realized as a program for allowing a computer to implement procedures equivalent to the invention (alternatively, for allowing the computer to function as a unit equivalent to the invention, or for allowing the computer to realize a function equivalent to the invention), which is also realized as a computer readable recording medium recording the program.

According to the invention, the present location and the identifier of the mobile terminal can be concealed.

### BRIEF DESCRIPTION OF THE DRAWINGS

The teachings of the invention can be readily understood by considering the following detailed description in conjunction with the accompanying drawings, in which:

FIG. 1 is a diagram illustrating the exemplary configuration of a network system in one embodiment of the invention;

FIG. 2 is a diagram illustrating the exemplary configuration of a mobile terminal in the embodiment;

FIG. 3 is a diagram illustrating the exemplary configuration of a tunnel server for location concealment in the embodiment;

FIG. 4 is a flowchart illustrating one example of the procedures of the mobile terminal in the embodiment;

FIG. 5 is a flowchart illustrating one example of the procedures when the tunnel server in the embodiment forwards a packet sent from the mobile terminal;

FIG. 6 is a flowchart illustrating one example of the procedures when the tunnel server in the embodiment forwards a packet sent from a correspondent terminal;

FIG. 7 is a diagram illustrating a first exemplary operation of the network system in the embodiment;

FIG. 8 is a diagram illustrating a second exemplary operation of the network system in the embodiment;

FIG. 9 is a diagram illustrating a third exemplary operation of the network system in the embodiment;

FIG. 10 is a diagram illustrating a fourth exemplary operation of the network system in the embodiment;

FIG. 11 is a diagram illustrating a fifth exemplary operation of the network system in the embodiment;

FIG. 12 is a diagram illustrating a sixth exemplary operation of the network system in the embodiment;

FIG. 13 is a diagram for explaining the exemplary configuration of the tunnel server;

FIG. 14 is a diagram illustrating the exemplary configuration of the network system in the embodiment;

FIG. 15 is a diagram illustrating the exemplary configuration of a tunnel server for location concealment in the embodiment;

FIG. 16 is a diagram illustrating a seventh exemplary operation of the network system in the embodiment;

FIG. 17 is a diagram illustrating an eighth exemplary operation of the network system in the embodiment;

FIG. 18 is a diagram illustrating another exemplary configuration of the network system in the embodiment;

FIG. 19 is a diagram illustrating a ninth exemplary operation of the network system in the embodiment; and

FIG. 20 is a diagram illustrating a tenth exemplary operation of the network system in the embodiment.

### DESCRIPTION OF THE PREFERRED EMBODIMENT

Hereafter, embodiments of the invention will be described with reference to the drawings.

First, an embodiment for allowing the present location of a mobile terminal to be concealed will be described.

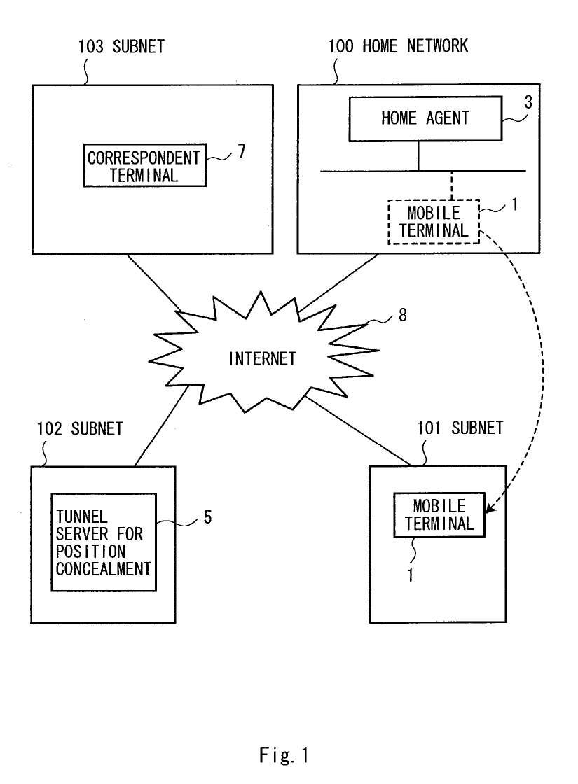

FIG. 1 depicts the exemplary configuration of a network system in one embodiment of the invention.

1 denotes a mobile terminal (Mobile Node (MN)), which is a terminal moving around on the networks. The mobile terminal 1 can be used in the existing Mobile IPv6 (that does not conceal the present location) and the extended Mobile IPv6 that conceals the present location.

100 denotes a home network where the mobile terminal 1 originally belongs.

The mobile terminal 1 has an address in the home network 100, that is, a home address (Haddr), and also acquires a present location address, that is, a care-of address (CoA) at the place where it has moved. It also acquires an address for location concealment (TSCoA) when it conceals the present location where it has moved.

3 denotes a home agent (HA) in Mobile IPv6, which supports the mobile terminal 1 moving around in the home network 100.

5 denotes a tunnel server for location concealment (TS), which performs the service to conceal the present location of the mobile terminal 1.

7 denotes a correspondent terminal (Correspondent Node (CN)), which is a terminal to communicate with the mobile terminal 1.

8 denotes a backbone network (IP network, for example, the Internet).

Moreover, it is fine that subnets 100 to 103 are directly connected to the backbone network 8 or not.

Besides, in the example shown in FIG. 1, the subnet 101 where the mobile terminal 1 in moving outside the home network 100 is located at present, the subnet 102 where the tunnel server for location concealment 5 belongs, and the subnet 103 where the correspondent terminal 7 belongs are depicted as different ones, but the case can be considered that all or a part of the subnets are the same.

In addition, the address of the home agent 3 is denoted as HA, the address of the tunnel server is denoted as TS, and the address of the correspondent terminal 7 is denoted as CN.

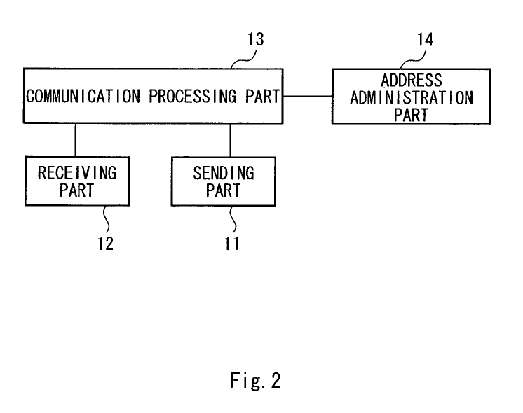

FIG. 2 depicts the exemplary configuration of the mobile terminal 1 in the embodiment.

As shown in FIG. 2, the mobile terminal 1 is provided with a sending part 11 for sending a packet to the networks, a receiving part 12 for receiving a packet from the networks, a communication processing part 13 for performing basic communication protocol processing such as datalink layer processing and TCP/IP protocol processing, processing as a mobile node of the existing Mobile IPv6 and processing that extends the processing for concealing the present location, and an address administration part 14 for storing and managing IPv6 addresses of the terminal (for example, the home address (Haddr), the present location address acquired at the place where it has moved, that is, the care-of address (CoA), and the address for location concealment (TSCoA)) and management information about them if necessary (for example, lifetime when the address has its lifetime). Furthermore, the mobile terminal 1 stores and manages the address of the tunnel server and a tunnel system to the tunnel server (for example, including authentication systems and keys) if necessary.

Moreover, the mobile terminal 1 is typically a calculator, but not limited to this. Any forms are acceptable including a mobile phone terminal and an information device, both having a function to connect to the Internet.

Besides, all or a part of the processes of the mobile terminal 1 can be implemented by a program, and all or a part of the processes can be implemented by a semiconductor integrated circuit for exclusive use.

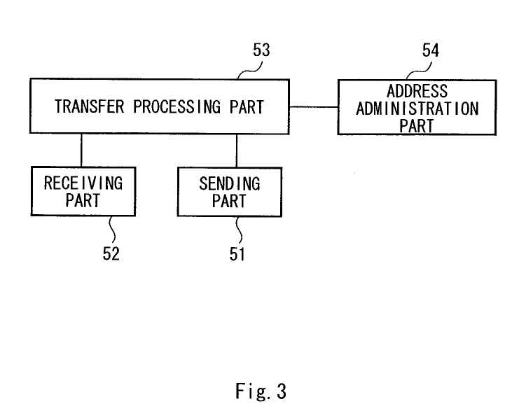

FIG. 3 depicts the exemplary configuration of the tunnel server for location concealment 5 in the embodiment.

As shown in FIG. 3, the tunnel server 5 is provided with a sending part 51 for sending a packet to the networks, a receiving part 52 for receiving a packet from the networks, a transmittal part 53 for performing transmittal of packets to conceal the present location of the mobile terminal, and an address administration part 54 for managing the address of the mobile terminal 1 to be a service target by the sever itself. For example, for each mobile terminal, the address administration part 54 stores and manages the address for location concealment (TSCoA) assigned to the mobile terminal in association with the actual present location address of the mobile terminal, that is, the care-of address (CoA), and/or the home address (Haddr) of the mobile terminal (alternatively, for example, it stores and manages the node identifier (such as the home address (Haddr), the host name or the e-mail address) of the mobile terminal in association).

In addition, the tunnel server 5 can be implemented by using a computer. Furthermore, all or a part of the processes of the tunnel server 5 can be implemented by a program. Alternatively, all or apart of the processes can be implemented by a semiconductor integrated circuit for exclusive use.

Here, two types of packet transfer modes will be described when the mobile terminal 1 selects the service of the existing Mobile IPv6. In addition, in the two types of packet transfer modes, one is a packet transfer mode in which the correspondent terminal 7 sends a packet to an address recognized as the home address of the mobile terminal 1 (hereafter, it is called basic transfer mode), and the other is a packet transfer mode in which the correspondent terminal 7 sends a packet to an address recognized as the present location address of the mobile terminal 1 (hereafter, it is called optimum transfer mode).

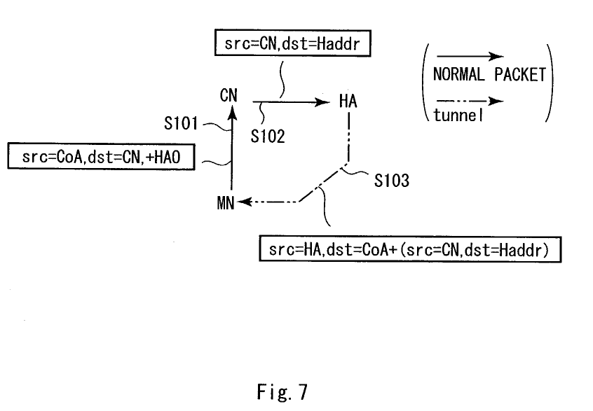

FIG. 7 depicts a packet flow in the basic transfer mode.

In FIG. 7, MN denotes the mobile terminal 1, CN denotes the correspondent terminal 7, and HA denotes the home agent 3. Furthermore, FIG. 7-depicts the source address src, the determination address dst, and the home address (HAO) described in the header of packets in each route. Moreover, in the case of an encapsulated packet, an address inside the IP packet is depicted in parentheses. These points are the same in the similar drawings referred below.

The mobile terminal 1 sends an IP packet containing the home address option (Haddr) where src=CoA and dst=CN. It is received by the correspondent terminal 7 (Step S101).

The correspondent terminal 7 sets where src=CN and dst=Haddr to send the IP packet. It is forwarded to the home network 100 of the mobile terminal 1, and received by the home agent 3 (Step S102).

The home agent 3 encapsulates the received IP packet where src=HA and dst=CoA, and sends the encapsulated packet. It is forwarded to the network 101 where the mobile terminal 1 has moved and received by the mobile terminal 1 (Step S103).

The mobile terminal 1 decapsulates the received encapsulated packet, and extracts the IP packet where src=CN and dst=Haddr.

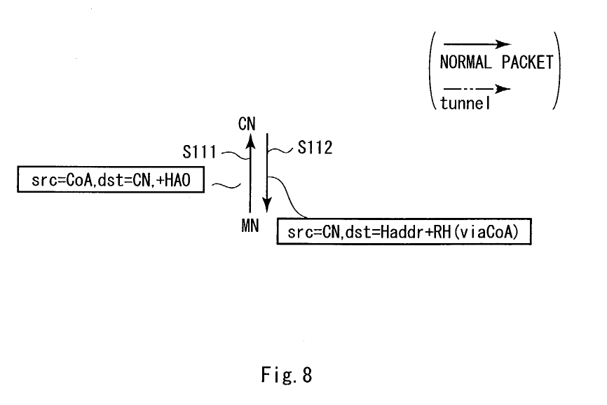

FIG. 8 depicts a packet flow in the optimum transfer mode.

The mobile terminal 1 sends an IP packet containing the home address option (Haddr) where src=CoA and dst=CN. The packet is received by the correspondent terminal 7 (Step S111).

The correspondent terminal 7 sets where src=CN and dst=Haddr+RH (via CoA) to send the IP packet. It is forwarded to the network 101 where the mobile terminal 1 has moved and received by the mobile terminal 1 (Step S112).

Moreover, dst=A+RH (B) shows that the final determination address is A via Address B.

In the meantime, in the case where a mobile terminal wants to conceal its present location address in the existing IPv6 network, an ingress filter is generally installed to block the packet and the packet will not delivered to the destination even though the mobile terminal simply lies and sends the source address of an on going packet. More specifically, to deliver the packet to the destination, the present location address needs to be described in the source address of the ongoing packet, and thus the present location cannot be concealed.

Then, in the embodiment, when the mobile terminal 1 obtains the Mobile IPv6 service to conceal the present location (CoA), it utilizes the tunnel server for location concealment 5. Furthermore, it is considered that the mobile terminal 1 can select the existing Mobile IPv6 service and the Mobile IPv6 service to conceal the present location (by a user or an application, for example) (more specifically, it is considered to select whether to conceal the present location in performing Mobile IPv6).

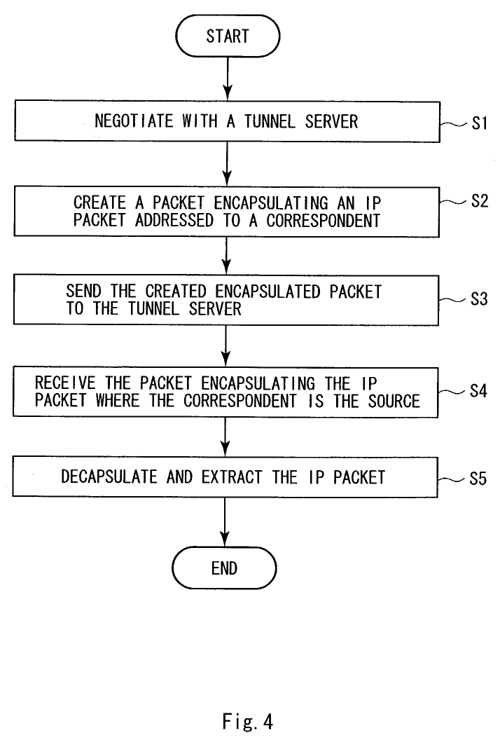

FIG. 4 depicts one example of the basic procedures when the present location of the mobile terminal 1 is concealed.

In addition, it is considered that the care-of address (CoA) has been acquired in the subnet 101 and the registration procedure for moving in the home agent 3 of the home network 100 has been done.

Furthermore, the mobile terminal 1 finds the tunnel server for location concealment 5 where the terminal is a service target, and stores the address of the tunnel server 5 (the address is TS) before or at the time when acquiring the address for location concealment (TSCoA). Moreover, it is fine that the method for finding the tunnel server 5 depends on a service provider.

In sending a packet concealing the present location, the mobile terminal 1 first requests the tunnel server 5 to negotiate with the tunnel server 5 and determines an address for location concealment (TSCoA) when it has not acquired the address for location concealment (TSCoA) yet (Step S1). Besides, it is fine that the method for negotiating the address for location concealment (TSCoA) depends on a provider administrating the tunnel server 5.

In addition, in the negotiation, the mobile terminal 1 posts its node identifier to the tunnel server 5. For example, the node identifier is considered to be the home address (Haddr) or FQDN (when TEA, which will be described later, is used as the node identifier, it is likely to overlap in posting CoA).

Furthermore, in the negotiation, the mobile terminal 1 posts a tunnel endpoint address (TEA) for passing the packet with the address for location concealment (TSCoA) to the tunnel server 5. As TEA corresponding to TSCoA, it is acceptable either to post the present care-of address (CoA) of the terminal, the home address (Haddr) of the terminal or both. Moreover, it is fine to determine which address to be posted beforehand or to determine the address properly on a case-by-case basis.

Besides, when the address for location concealment (TSCoA) has already been acquired, skip Step S1.

Therefore, the mobile terminal 1 produces an IP packet where the address of the correspondent terminal 7 is the determination address and the address for location concealment (TSCoA) is the source address, and creates an encapsulated packet in which the IP packet is encapsulated to the tunnel server 5 (Step S2).

Then, the created encapsulated packet is sent to the tunnel server 5 (Step S3).

In addition, the mobile terminal 1 receives the encapsulated packet having further encapsulated the IP packet where the correspondent terminal 7 is the source and the terminal itself is the destination (Step S4), and then it decapsulates the packet to extract the IP packet (Step S5). Subsequently, it processes the IP packet properly.

Furthermore, the procedures shown in FIG. 4 are one example. For instance, when the terminal receives the request from the correspondent terminal 7 and sends back the response to the request, the processes at Steps S4 and S5, a response process, and the processes at Steps S2 and S3 are sequentially performed in this order.

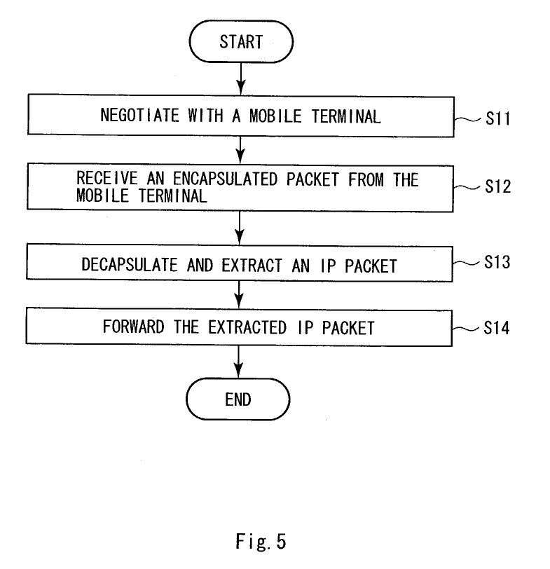

FIG. 5 depicts one example of the basic procedures of the tunnel server 5 when a packet sent from the mobile terminal 1 is forwarded.

First, when the mobile terminal 1 requests negotiation, the server negotiates with the mobile terminal 1, assigns an address for location concealment (TSCoA), receives the notification of TEA corresponding to the node identifier or TSCoA, and stores them in association (Step S11).

Therefore, the tunnel server for location concealment 5 receives an encapsulated packet from the mobile terminal 1 (in which the IP packet where the address of the correspondent terminal 7 is the determination address and the address for location concealment (TSCoA) is the source address is encapsulated) (Step S12). Then, the server decapsulates and extracts an IP packet (where the address of the correspondent terminal 7 is the determination address and the address for location concealment (TSCoA) is the source address) (Step S13), and forwards the extracted IP packet (to the correspondent terminal 7) (Step S14).

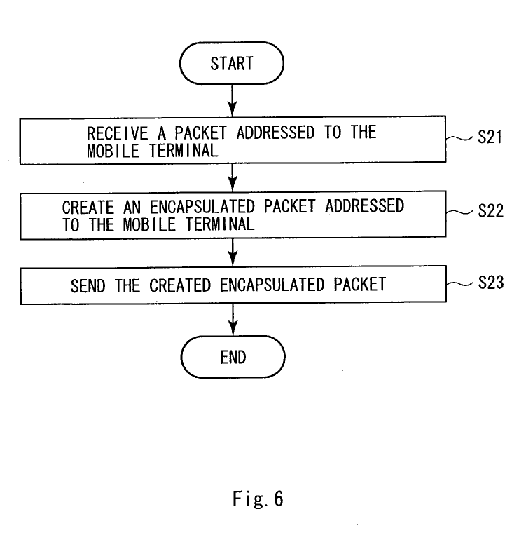

FIG. 6 depicts one example of the basic procedures of the tunnel server 5 when a packet sent from the correspondent terminal 7 is forwarded.

In addition, when the packet transfer mode is selected in which a packet sent from the correspondent terminal 7 to the mobile terminal 1 is forwarded not via the tunnel server 5, the tunnel server 5 will not perform the procedures.

When the tunnel server for location concealment 5 receives an IP packet addressed to the mobile terminal 1 (Step S21), it further encapsulates the packet addressed to the mobile terminal 1 and creates an encapsulated packet (Step S22). The server forwards the created encapsulated packet (to a mobile terminal 17) (Step S23).

In the meantime, hereafter, various packet transfer modes will be described when the mobile terminal 1 having moved outside the home network 100 selects the Mobile IPv6 service to conceal the present location.

(Case A: CoA of the Mobile Terminal is Used as TEA Corresponding to TSCoA)

First, the case will be shown in which the mobile terminal 1 posts the present care-of address (CoA) of the terminal as TEA corresponding to the address for location concealment (TSCoA) to the tunnel server for location concealment 5 (alternatively, the case where it posts the home address (Haddr) and the present care-of address (CoA) of the terminal as TEA corresponding to TSCoA and the tunnel server for location concealment 5 selects the present care-of address (CoA) of the mobile terminal 1 as TEA corresponding to TSCoA).

The case where the present care-of address (CoA) of the mobile terminal 1 is used as TEA corresponding to the address for location concealment (TSCoA) is efficient in view of the route (however, the-registered contents (including CoA) need to be updated not only to the home agent 3 but also to the tunnel server for location concealment 5 when the mobile terminal 1 has moved). In addition, when the present care-of address (CoA) of the mobile terminal 1 is used as TEA corresponding to the address for location concealment (TSCoA), it is fine that the mobile terminal 1 (or the tunnel server 5 having assigned the address for location concealment (TSCoA) to the mobile terminal 1) posts the address for location concealment (TSCoA) to the home agent 3.

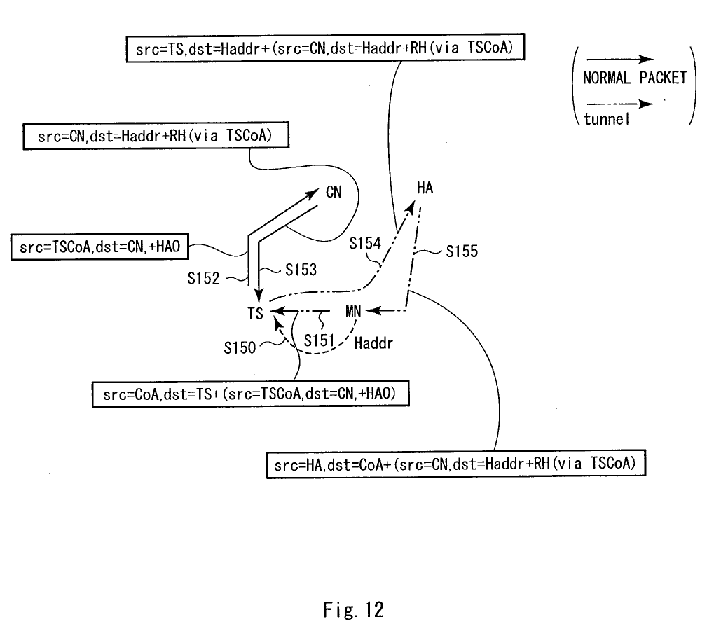

Furthermore, Case A is advantageous over Case B below in packaging (for example, the packet received by the mobile terminal has RH and it is needed to recognize that TSCoA is the address of the terminal, with reference to an example shown in FIG. 12).

The basic transfer mode in which the correspondent terminal 7 sends a packet to the address recognized as the home address of the mobile terminal 1, and the optimum transfer mode in which the correspondent terminal 7 sends a packet to the address recognized as the present location address of the mobile terminal 1 are also shown here.

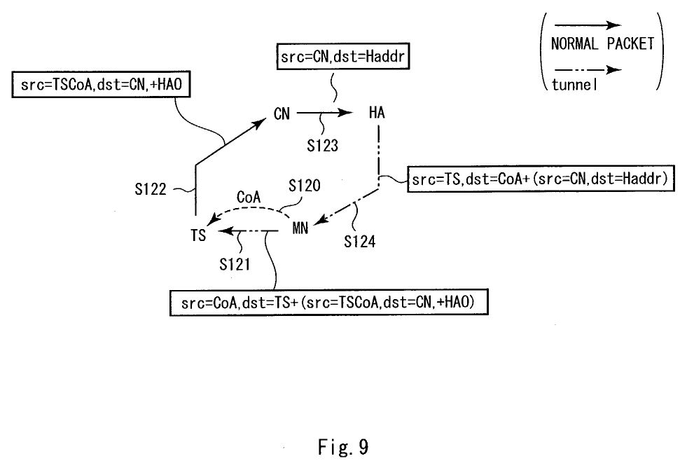

FIG. 9 depicts a packet flow in the basic transfer mode.

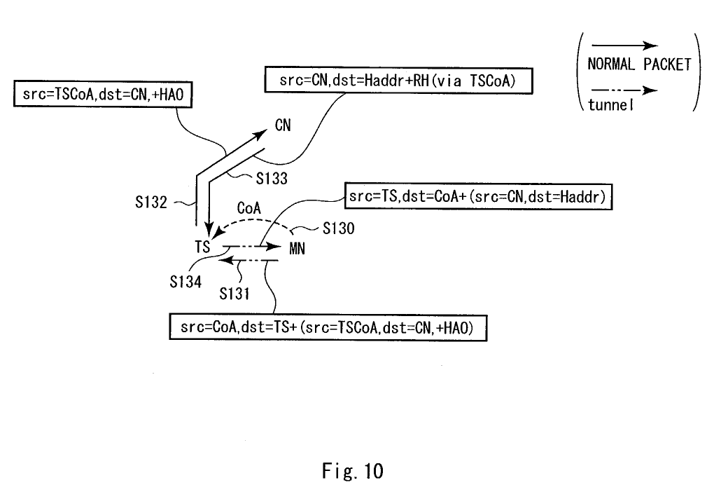

In addition, in FIG. 9, TS denotes the tunnel server for location concealment 5. This point is the same in FIGS. 10 to 12, which will be referred later.

The mobile terminal 1 is considered to have posted CoA as TEA corresponding to TSCoA to the tunnel server 5. (Step S120).

The mobile terminal 1 sets where src=TSCoA and dst=CN and encapsulates an IP packet containing the home address option (Haddr) where src=CoA and dst=TS, and sends the encapsulated packet. Then, it is received by the tunnel server 5 (Step S121).

The tunnel server 5 decapsulates the received encapsulated packet to set where src=TSCoA and dst=CN, extracts the IP packet containing the home address option (Haddr), and forwards it. Then, it is received by the correspondent terminal 7 (Step S122).

The correspondent terminal 7 sets where src=CN and dst=Haddr, and sends the IP packet. It is forwarded to the home network 100 of the mobile terminal 1, and received by the home agent 3 (Step S123).

The home agent 3 encapsulates the received IP packet where src=HA and dst=CoA, and sends the encapsulated packet. It is forwarded to the network 101 where the mobile terminal 1 has moved, and received by the mobile terminal 1 (Step S124).

The mobile terminal 1 decapsulates the received encapsulated packet, and extracts the IP packet where src=CN and dst=Haddr.

FIG. 10 depicts a packet flow in the optimum transfer mode.

The mobile terminal 1 is considered to have posted CoA as TEA corresponding to TSCoA to the tunnel server 5 (Step S130).

The mobile terminal 1 sets where src=TSCoA and dst=CN, encapsulates an IP packet containing the home address option (Haddr) where src=CoA and dst=TS, and sends the encapsulated packet. Then, it is received by the tunnel server 5 (Step S131).

The tunnel server 5 decapsulates the received encapsulated packet and sets where src=TSCoA and dst=CN. The server extracts and forwards the IP packet containing the home address option (Haddr). Then, it is received by the correspondent terminal 7 (Step S132).

The correspondent terminal 7 sets where src=CN and dst=Haddr+RH (via TSCoA), and sends the IP packet. It is forwarded to the subnet 102, and received by the tunnel server 5 (Step S133).

The tunnel server 5 knows the mobile terminal 1 corresponding to the final destination Haddr of the received packet. Thus, it retrieves the present TEA, and sends an encapsulated packet in which the received IP packet is encapsulated where src=TS and dst=TEA, that is, CoA. It is forwarded to the network 101 where the mobile terminal 1 has moved, and received by the mobile terminal 1 (Step S134).

The mobile terminal 1 decapsulates the received encapsulated packet, and extracts the IP packet where src=CN and dst=Haddr.

(Case B: The Case Where Haddr of the Mobile Terminal is Used as TEA Corresponding to TSCoA)

Next, the case will be shown in which the home address (Haddr) of the terminal is posted to the tunnel server for location concealment 5 from the mobile terminal 1 as TEA corresponding to the address for location concealment (TSCoA) (alternatively, the case where the home address (Haddr) and the present care-of address (CoA) of the terminal are posted as TEA corresponding to TSCoA and the tunnel server for location concealment 5 selects the home address (Haddr) of the mobile terminal 1 as TEA corresponding to TSCoA).

When the present home address (Haddr) of the mobile terminal 1 is used as TEA corresponding to the address for location concealment (TSGoA), it does not need to be posted to the tunnel server for location concealment 5 even though the mobile terminal is moved.

In addition, in this case, the mobile terminal 1 needs to recognize that TSCoA assigned by the tunnel server 5 is the address owned by the terminal itself. Furthermore, TSCoA is the address managed by the tunnel server 5, but preferably it is not the address assigned by the tunnel server 5 to its interface.

Similarly, the basic transfer mode in which the correspondent terminal 7 sends a packet to the address recognized as the home address of the mobile terminal 1 and the optimum transfer mode in which the correspondent terminal 7 sends a packet to the address recognized as the present location address of the mobile terminal 1 will be shown here.

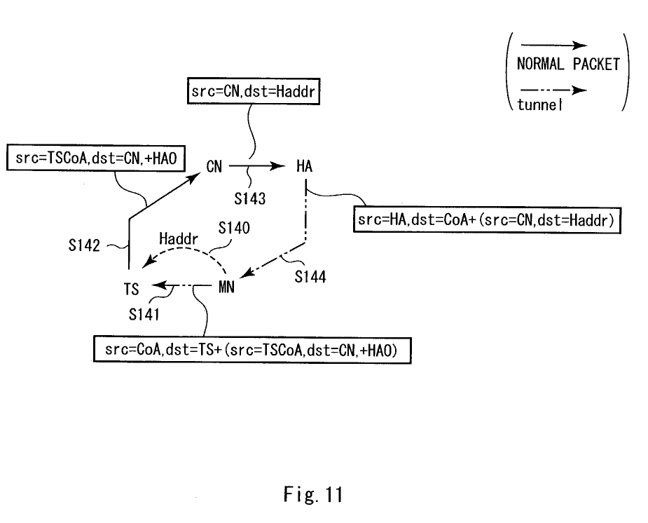

FIG. 11 is a packet flow in the basic transfer mode.

The mobile terminal 1 is considered to have posted Haddr as TEA corresponding to TSCoA to the tunnel server 5 (Step S140). After this, the flow is the same as that shown in FIG. 9.

FIG. 12 is a packet flow in the optimum transfer mode.

The mobile terminal 1 is considered to have posted Haddr as TEA corresponding to TSCoA to the tunnel server 5 (Step S150).

The mobile terminal 1 sets where src=TSCoA and dst=CN, encapsulates an IP packet containing the home address option (Haddr) where src=CoA, dst=TS, and sends the encapsulated packet. Then, it is received by the tunnel server 5 (Step S151).

The tunnel server 5 decapsulates the received encapsulated packet, sets where src=TSCoA and dst=CN. The server extracts and forwards the IP packet containing the home address option (Haddr). Then, it is received by the correspondent terminal 7 (Step S152).

The correspondent terminal 7 sends the IP packet where src=CN and dst=Haddr+RH (via TSCoA), and it is forwarded to the subnet 102 and received by the tunnel server 5 (Step S153).

The tunnel server 5 knows the mobile terminal 1 corresponding to the final destination=Haddr of the received packet. Thus, the server retrieves the present TEA, encapsulates the received IP packet where src=TS and dst=TEA, that is, Haddr, and sends the encapsulated packet. It is forwarded to the home network 100 of the mobile terminal 1, and received by the home agent 3 (Step S154).

In addition, when this transfer mode is selected, the mobile terminal 1 or the tunnel server 5 having assigned TSCoA to the mobile terminal 1 posts the home agent 3 that the tunnel server 5 is likely to forward the encapsulated packet addressed to the home address of the mobile terminal 1. The home agent 3 having received the notification re-encapsulates the encapsulated packet addressed to the home address of the mobile terminal 1, the packet has been forwarded from the tunnel server 5, and forwards it to the present location of the mobile terminal 1.

Therefore, the home agent 3 temporarily decapsulates the received encapsulated packet, extracts the IP packet where src=CN and dst=Haddr+RH (via TSCoA), encapsulates the IP packet where src=HA and dst=CoA, and sends the encapsulated packet. Then, it is forwarded to the network 101 where the mobile terminal 1 has moved, and received by the mobile terminal 1 (Step S155).

The mobile terminal 1 decapsulates the received encapsulated packet, and extracts the IP packet where src=CN and dst=Haddr+RH (via TSCoA).

In the meantime, it is acceptable to allow the tunnel server 5 to allocate lifetime for TSCoS. The mobile terminal 1 can negotiate with the tunnel server 5 about assigning new TSCoA (or extending the current TSCoA) at an arbitrary point before lifetime is expired. When the tunnel server 5 itself is switched, it is fine to post the tunnel server 5 that the address is released or to wait to expire lifetime.

In addition, it is acceptable that the tunnel server 5 and the mobile terminal 1 tunnel the packet forward/backward with authentication if required. For example, it is fine to tunnel the packet with the use of AH/ESP, or to send the IP Packet over SSL (more specifically, the original IPv6 packet over SSL over TCP over IPv6).

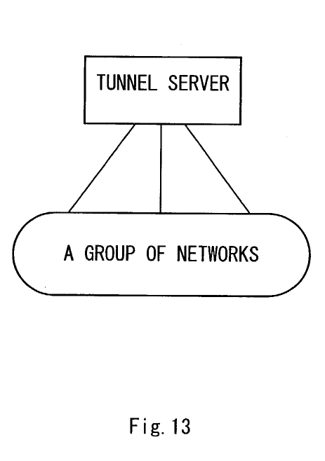

It becomes a tunnel between the tunnel server 5 and the mobile terminal 1. However, when how far or how slow is a problem, it is acceptable that the tunnel server 5 is disposed near the top when constructed in a star shape and TSCoA of the terminal is told to the tunnel server 5 as shown in FIG. 13, for example (it makes no sense in telling Haddr because the packet jumps to HA). In this case, it is fine to allocate another prefix non-associated with the networks below for the tunnel server 5.

Furthermore, the prefix for location concealment (it is an origin for address for location concealment (TSCoA)) held by the tunnel server 5 is changed at regular intervals, and therefore the location privacy can be further improved. However, when the prefix used in TSCoA being assigned at present is used, such procedures are taken that the prefix is kept until its lifetime is expired, or that a request is made to the mobile terminal 1 to switch new TSCoA.

Next, hereafter, an embodiment will be described in which the present location and the identifier of the mobile terminal can be concealed.

It is fine that for the identifier privacy, TSCoA′ is assigned from a certain tunnel server for a long time, it is used as the pseudo home address (instead of Haddr), and TSCoA assigned from another tunnel server is used as the address for location concealment (instead of CoA, for a short time).

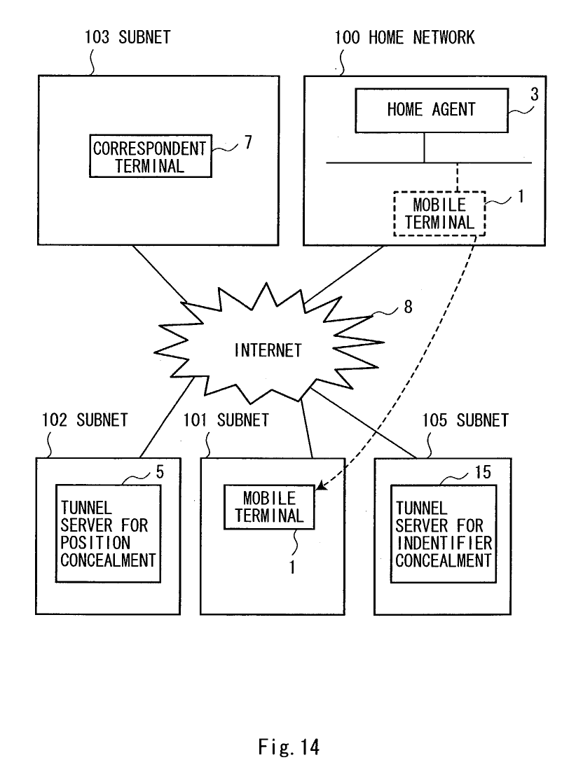

FIG. 14 depicts the exemplary configuration of the network system in this case.

The point different from FIG. 1 is that a tunnel server (tunnel server (TS)) 15 for providing the service to conceal the identifier (Haddr) of the mobile terminal 1 is added.

In addition, as similar to the case shown in FIG. 1, a subnet 105 is fine to be directly connected to a backbone network 8 or not. Furthermore, subnets 101, 102, 103 and 105 are all different from each other in the example shown in FIG. 1, but the case is possible that all or a part of the subnets are the same.

Moreover, the address of a tunnel server for location concealment 5 is denoted as TS1, and the address of the tunnel server for identifier concealment 15 is denoted as TS2, here.

Hereafter, the points different from the description so far will be mainly described.

The tunnel server for identifier concealment 15 assigns an address for identifier concealment (Pseudo Home Address (PHaddr)) used as a pseudo home address to a mobile terminal 1.

Besides, the address for location concealment assigned by the tunnel server for location concealment 5 is denoted as TSCoA as described so far, and the address for identifier concealment assigned by the tunnel server for identifier concealment 15 is denoted as TSCoA2.

When the mobile terminal 1 obtains the service of the tunnel server for location concealment 5 and the service of the tunnel server for identifier concealment 15, the tunnel server for location concealment 5 transfers the packet in the packet transfer from the mobile terminal 1 to the correspondent terminal 7, whereas the tunnel server for identifier concealment 15 transfers the packet in the packet transfer from the correspondent terminal 7 to mobile terminal 1. In this case, the tunnel server for location concealment 5 will not perform the operation shown in FIG. 6. On the other hand, the tunnel server for identifier concealment 15 will perform the operation shown in FIG. 6.

The points that the mobile terminal 1 negotiates with the tunnel server for identifier concealment 15 to obtain the address for identifier concealment (TSCoA2) and that the tunnel server for identifier concealment 15 receives the notification of TEA corresponding to the node identifier or TSCoA from the mobile terminal 1 to store them in association are the same as the mobile terminal 1 and the tunnel server for location concealment 5 described so far. However, when the configuration of setting lifetime is adopted, the lifetime of the address for identifier concealment (TSCoA2) is preferably set longer (because the short lifetime of TSCoA2 might cause troubles when updating cannot be done).

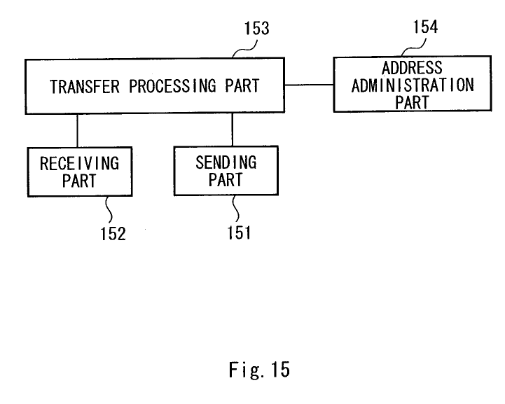

FIG. 15 depicts the exemplary configuration of the tunnel server for identifier concealment 15 in the embodiment.

As shown in FIG. 15, the tunnel server.15 is provided with a sending part 151 for sending a packet to the networks, a receiving part 152 for receiving a packet from the networks, a transmittal part 153 for performing transmittal of a packet for concealing the mobile terminal identifier (Haddr) of the mobile terminal, and an address administration part 154 for managing the addresses of the mobile terminal 1 to be the service target by the server itself. For example, the address administration part 154 stores and manages the address for identifier concealment (TSCoA2) assigned to the mobile terminal in association with the actual present location address, that is, the care-of address (CoA) of the mobile terminal and/or the home address (Haddr) of the mobile terminal on each mobile terminal (alternatively, in addition to this, it stores and manages the node identifier (such as the home address (Haddr), the host name or the e-mail address) of the mobile terminal in association).

Additionally, the tunnel server 15 can be implemented by using a computer. Furthermore, all or a part of the processes of the tunnel server 15 can be implemented by a program, or all or a part of the processes can be implemented by a semiconductor integrated circuit for exclusive use.

Moreover, in FIG. 14, the tunnel server for location concealment 5 and the tunnel server for identifier concealment 15 are depicted as the different servers belonging to the different subnets. However, the configuration is acceptable that the tunnel server for location concealment 5 and the tunnel server for identifier concealment 15 are configured as one server. In this case, the mobile terminal 1 can obtain the services to conceal the location and the identifier from the same tunnel server.

Here, the mobile terminal 1 is considered to select the existing Mobile IPv6 service of concealing neither the present location nor the identifier, the Mobile IPv6 service of concealing the present location, the Mobile IPv6 service of concealing the identifier, and the Mobile IPv6 service of concealing both the present location and the identifier (by a user or an application, for example).

Hereafter, the cases in the basic transfer mode will be shown as the packet transfer modes when the mobile terminal 1 having moved outside the home network 100 selects the Mobile IPv6 service of concealing both the present location and the identifier: the case where Haddr of the mobile terminal is used as TEA corresponding to TSCoA2, and the case where CoA of the mobile terminal is used as TEA corresponding to TSCoA2. In addition, any TEA corresponding to TSCoA is acceptable.

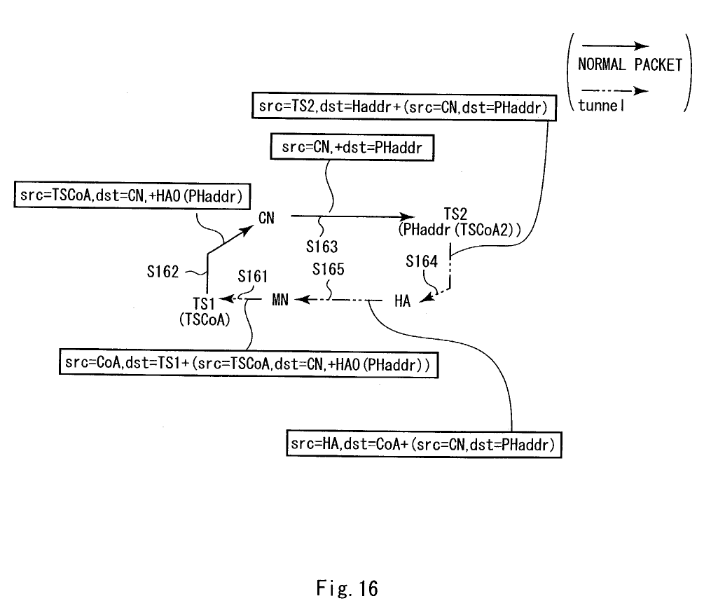

FIG. 16 depicts a packet flow when the home address (Haddr) is registered as the present location to the tunnel server 15 for providing PHaddr=TSCoA.

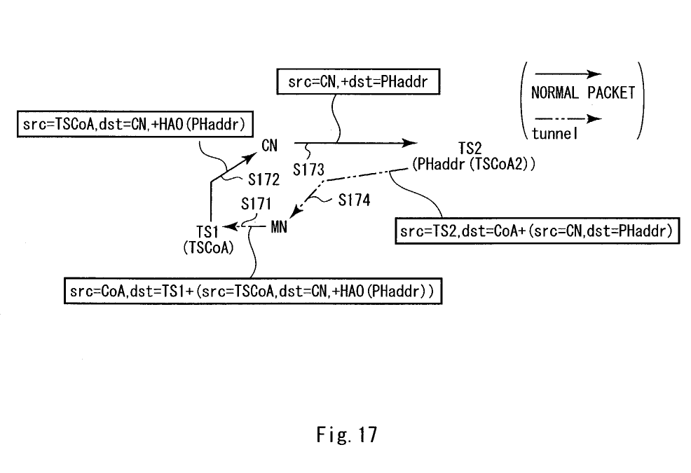

Furthermore, in FIG. 16, TS1 denotes the tunnel server for location concealment 5, and TS2 denotes the tunnel server for identifier concealment 15. This point is the same as FIG. 17 referred later.

The mobile terminal 1 is considered to have posted Haddr as TEA corresponding to TSCoA to the tunnel server 15.

The mobile terminal 1 set where src=TSCoA and dst=CN, encapsulates an IP packet containing the home address option (PHaddr) where src=CoA and dst=TS1, and sends the encapsulated packet. Then, it is received by the tunnel server 5 (Step S161).

The tunnel server 5 decapsulates the received encapsulated packet, sets where src=TSCoA and dst=CN, extracts and forwards the IP packet containing the home address option (PHaddr). Then, it is received by the correspondent terminal 7 (Step S162).

The correspondent terminal 7 sends the IP packet where src=CN and dst=PHaddr. It is forwarded to the network 105 to be the pseudo home network of PHaddr, and received by the tunnel server 15 (Step S163).

The tunnel server 15 encapsulates the received IP packet where src=TS2 and dst=Haddr, and sends the encapsulated packet. It is forwarded to the home network 100 of the mobile terminal 1, and received by the home agent 3 (Step S164).

Moreover, when this transfer mode is selected, the mobile terminal 1 or the tunnel server 15 having assigned TSCoA2 to the mobile terminal 1 posts the home agent 3 that the tunnel server 15 is likely to forward the encapsulated packet addressed to the home address of the mobile terminal 1. The home agent 3 having received the notification re-encapsulates the encapsulated packet addressed to the home address of the mobile terminal 1, the packet has been forwarded from the tunnel server 15, and forwards it to the present location of the mobile terminal 1.

Therefore, the home agent 3 temporarily decapsulates the received encapsulated packet, extracts the IP packet where src=CN and dst=PHaddr, encapsulates it where src=HA and dst=CoA, and sends the encapsulated packet. It is forwarded to the network 101 where the mobile terminal 1 has moved, and received by the mobile terminal 1 (Step S165).

The mobile terminal 1 decapsulates the received encapsulated packet, and extracts the IP packet where src=CN and dst=PHaddr.

FIG. 17 depicts a packet flow when the care-of address (CoA) is registered as the present location to the tunnel server 15 for providing PHaddr=TSCoA.

In addition, in this case, when the mobile terminal 1 is moved, the registered contents (including CoA) need to be updated not only for the home agent but also for the tunnel server for identifier concealment 15.

The mobile terminal 1 is considered to have posted CoA as TEA corresponding to TSCoA to the tunnel server 15.

The mobile terminal 1 sets where src=TSCoA and dst=CN, encapsulates an IP packet containing the home address option (PHaddr) where src=CoA and dst=TS1, and sends the encapsulated packet. Then, it is received by the tunnel server 5 (Step S171).

The tunnel server 5 decapsulates the received encapsulated packet, sets where src=TSCoA and dst=CN, and extracts and forwards the IP packet containing-the home address option (PHaddr). Then, it is received by the correspondent terminal 7 (Step S172).

The correspondent terminal 7 sends the IP packet where src=CN and dst=PHaddr. It is forwarded to the network 105 to be the pseudo home network of PHaddr to be the pseudo home address, and received by the tunnel server 15 (Step S173).

The tunnel server 15 encapsulates the received IP packet where src=TS2 and dst=CoA, and sends the encapsulated packet. Subsequently, it is forwarded to the network 101 where the mobile terminal 1 has moved, and received by the mobile terminal 1 (Step S174).

The mobile terminal 1 decapsulates the received encapsulated packet, and extracts the IP packet where src=CN and dst=PHaddr.

Furthermore, omitting the description here, the two cases on the optimum transfer mode are also possible as similar to the description so far.

Hereafter, the cases will be described on the basic transfer mode as the packet transfer modes when the mobile terminal 1 having moved outside the home network 100 selects the Mobile IPv6 service of concealment: the case where Haddr of the mobile terminal is used as TEA corresponding to TSCoA2, and the case where CoA of the mobile terminal is used as TEA corresponding to TSCoA2. Additionally, in the cases, any TEA corresponding to TSCoA is acceptable.

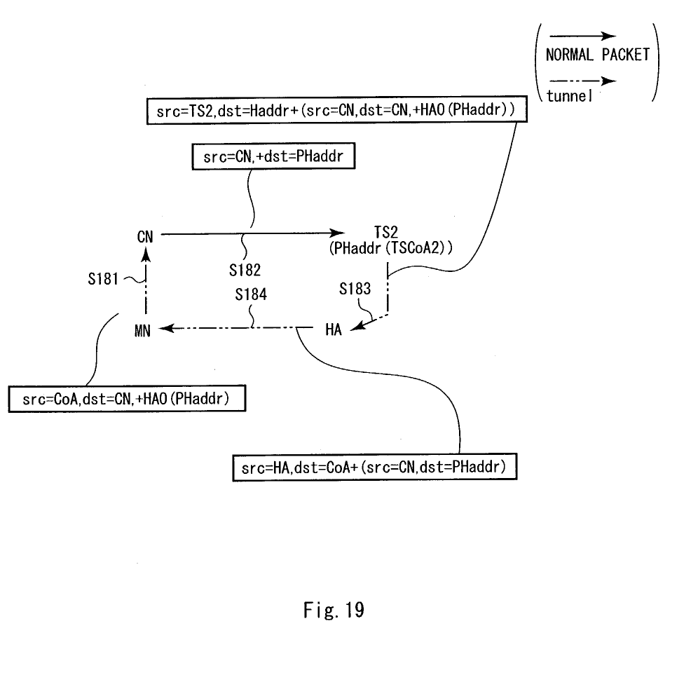

FIG. 19 depicts a packet flow when the home address (Haddr) is registered as the present location to the tunnel server 15 for providing PHaddr=TSCoA.

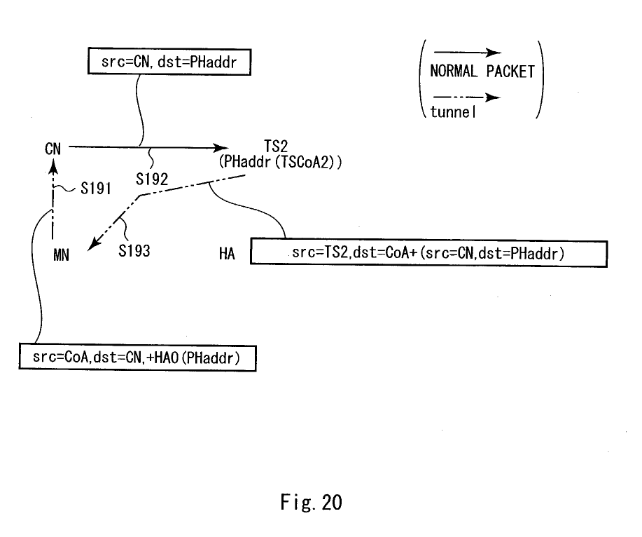

Furthermore, in FIG. 19, TS2 denotes the tunnel server for identifier concealment 15. This point is the same in FIG. 20 referred later.

The mobile terminal 1 is considered to have posted Haddr as TEA corresponding to TSCoA to the tunnel server 15.

The mobile terminal 1 sets where src=CoA and dst=CN, and sends an IP packet containing the home address option (PHaddr). Then, it is received by the correspondent terminal 7 (Step S181).

After this, it is the same as the case shown in FIG. 16.

FIG. 20 depicts a packet flow when the care-of address (CoA) is registered as the present location to the tunnel server 15 for providing PHaddr=TSCoA.

Moreover, in this case, when the mobile terminal 1 is moved, the registered contents (including CoA) need to be updated not only for the home agent but also the tunnel server for identifier concealment 15.

The mobile terminal 1 is considered to have posted CoA as TEA corresponding to TSCoA to the tunnel server 15.

The mobile terminal 1 sets where src=CoA and dst=CN, and sends an IP packet containing the home address option (PHaddr). Subsequently, it is received by the correspondent terminal 7 (Step S191).

After this, it is the same as the case shown in FIG. 17.

Moreover, omitting the description here, the optimum transfer mode corresponding to the case shown in FIG. 19 or FIG. 20 is also possible as similar to the description so far.

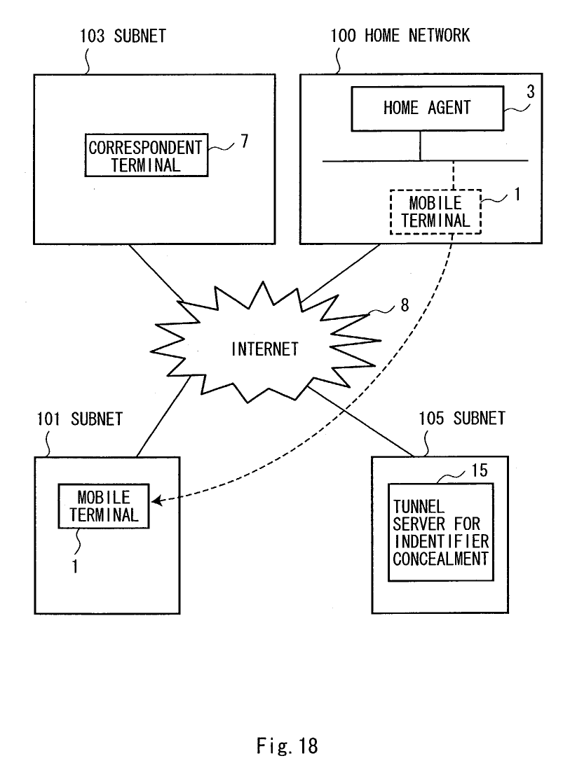

In the meantime, as shown in FIG. 18, the configuration of the network system is possible in which the server for location concealment 5 is not used.

In this case, the mobile terminal 1 can select the existing Mobile IPv6 service and the Mobile IPv6 service to conceal the identifier (by a user or an application, for example).

The packet flow in various transfer modes is as described so far.

In addition, each of the functions can be implemented as software.

Furthermore, the embodiments can be implemented as a program for allowing a computer to operate a predetermined unit (alternatively, for allowing the computer to function as a predetermined unit, or for allowing the computer to realize a predetermined function), which can be implemented as a computer readable recording-medium as well.

Moreover, the configurations shown in the embodiments of the invention are examples, which do not mean to exclude the other configurations, allowing other configurations obtained by omitting a part of the configuration, by adding another function or component to the exemplified configurations, or by combining them. Besides, another configuration logically equivalent to the exemplified configurations, another configuration including a portion logically equivalent to the exemplified configurations, and another configuration logically equivalent to the essential part of the exemplified configurations are also possible. Besides, another configuration achieving the same or comparable purpose as the exemplified configurations, and another configuration exerting the same or comparable advantage as the exemplified configurations can also be possible. Additionally, various variations on a variety of the components exemplified in the embodiments can be implemented-by combining them properly.

Furthermore, the embodiments of the invention incorporate and include the invention in various viewpoints, steps, concepts or categories, such as the invention of a separate apparatus, the invention of two or more relevant devices, the invention as the whole system, the invention of the components inside the separate apparatus, and the invention of a method corresponding to them. Accordingly, the invention can be extracted from the description disclosing the embodiments of the invention, not limited to the exemplified configurations.

The invention is not limited to the embodiments, which can be implemented variously in the technical scope.

According to the invention, the present location and the identifier of the mobile terminal can be-concealed.

What is claimed is:

1. A transmission control method of a server apparatus for providing a service to a mobile terminal device allowing packet transfer processing according to Mobile IPv6 protocols, the service to conceal a care-of address acquired by the mobile terminal device at its present location, the method comprising:
assigning an address for location concealment to be used as a pseudo care-of address to the mobile terminal device;
receiving an encapsulated packet from the mobile terminal device in which an IP packet containing the address for location concealment of the mobile terminal device as a source address, an address of a correspondent terminal as a determination address and a home address of the mobile terminal device is encapsulated where the care-of address of the mobile terminal device is a source address and an address of the server apparatus is a determination address;
decapsulating the received encapsulated packet to extract the IP packet; and
sending the extracted IP packet.

2. The transmission control method according to claim 1 comprising:
receiving an IP packet where the address of the correspondent terminal is the source address and a final determination address via the address for location concealment of the mobile terminal device is the home address of the mobile terminal from the correspondent terminal;
creating an encapsulated packet in which an IP packet where the address of the correspondent terminal and the home address of the mobile terminal contained in the received IP packet are a source address and a determination address is encapsulated where the address of the server apparatus of the mobile terminal device is a source address and the care-of address of the mobile terminal device is a determination address; and
sending the created encapsulated packet.

3. The transmission control method according to claim 1 comprising:
receiving an IP packet where the address of the correspondent terminal is a source address and a final determination address via the address for location concealment of the mobile terminal device is the home address of the mobile terminal from the correspondent terminal;
creating an encapsulated packet in which the received IP packet is encapsulated where the address of the server apparatus of the mobile terminal is a source address and the home address of the mobile terminal device is a determination address; and
sending the created encapsulated packet.

4. The transmission control method according to any one of claims 1 to 3, wherein the home address of the mobile terminal device is an actual home address held by the mobile terminal device.

5. The transmission control method according to claims 1 to 3, wherein the home address of the mobile terminal device is not an actual home address held by the mobile terminal device, the home address is a pseudo home address of the address for identifier concealment acquired by a calculator in moving.

6. A transmission control method of a server apparatus for providing a service to a mobile terminal device allowing packet transfer processing according to Mobile IPv6 protocols, the service to conceal a home address actually held by the mobile terminal device, the method comprising:
assigning an address for identifier concealment to be used as a pseudo home address to the mobile terminal device;
receiving an IP packet from a correspondent terminal of the mobile terminal device in which an address of the correspondent terminal is a source address and the address for identifier concealment of the mobile terminal device is a determination address;
creating an encapsulated packet in which the received IP packet is encapsulated where an address of the server apparatus is a source address and a care-of address or the actual home address of the mobile terminal device is a determination address; and
sending the created encapsulated packet.

7. A transmission control method of a home agent apparatus disposed in a home network of a mobile terminal device allowing packet transfer processing according to Mobile IPv6 protocols, the method comprising:
receiving an encapsulated packet from a predetermined server apparatus in which an IP packet where an address of a correspondent terminal of the mobile terminal device is a source address and a predetermined address of the mobile terminal device is a determination address is encapsulated where the predetermined server apparatus is a source address and a home address of the mobile terminal device is a determination address;
decapsulating the received encapsulated packet to extract the IP packet;
creating an encapsulated packet in which the extracted IP packet is encapsulated where an address of the home agent apparatus is a source address and a care-of address of the mobile terminal device is a determination address; and
sending the created encapsulated packet.

8. A transmission control method of a mobile terminal device allowing packet transfer processing according to Mobile IPv6 protocols, the method comprising:
acquiring an address for location concealment to be used as a pseudo care-of address from a server apparatus for providing a service to conceal a care-of address acquired by the mobile terminal device at its present location;
creating an encapsulated packet in which an IP packet containing the acquired address for location concealment as a source address, an address of a correspondent terminal as a determination address and an actual home address of the mobile terminal device is encapsulated where the care-of address of the mobile terminal device is a source address and an-address of the server apparatus is a determination address; and
sending the created encapsulated packet.

9. A transmission control method of a mobile terminal device allowing packet transfer processing according to Mobile IPv6 protocols, the method comprising:
acquiring an address for location concealment to be used as a pseudo care-of address from a first server apparatus for providing a service to conceal a care-of address acquired by the mobile terminal device at its present location and acquiring an address for identifier concealment to be used as a pseudo home address from a second server apparatus for providing a service to conceal a home address actually held by the mobile terminal device;
creating an encapsulated packet in which an IP packet containing the acquired address for location concealment as a source address, an address of a correspondent terminal as a determination address and the address for identifier concealment as the home address of the mobile terminal device is encapsulated where an actual care-of address of the mobile terminal device is a source address and an address of the first server apparatus is a determination address; and
sending the created encapsulated packet.

10. A transmission control method of a mobile terminal device allowing packet transfer processing according to Mobile IPv6 protocols, the method comprising:
acquiring an address for identifier concealment to be used as a pseudo home address from a server apparatus for providing a service to conceal a home address actually held by the mobile terminal device;
creating an IP packet containing a care-of address acquired by the mobile terminal device at its present location as a source address, an address of a correspondent terminal as a determination address and the address for identifier concealment as the home address of the mobile terminal device; and
sending the created IP packet.

11. A server apparatus for providing a service to conceal a care-of address acquired by a mobile terminal device at its present location, the mobile terminal device allowing packet transfer processing according to Mobile IPv6 protocols, the server apparatus comprising:
a unit adapted to assign an address for location concealment to be used as a pseudo care-of address to the mobile terminal device;
a unit adapted to receive from the mobile terminal device an encapsulated packet in which an IP packet containing the address for location concealment of the mobile terminal device as a source address, an address of a correspondent terminal as a determination address and a home address of the mobile terminal device is encapsulated where a care-of address of the mobile terminal device is a source address and an address of the server apparatus is a determination address;
a unit adapted to decapsulate the received encapsulated packet to extract the IP packet; and
a unit adapted to send the extracted IP packet.

12. A server apparatus for providing a service to conceal a home address actually held by a mobile terminal device, the terminal device allowing packet transfer processing according to Mobile IPv6 protocols, the server apparatus comprising:
a unit adapted to assign an address for identifier concealment to be used as a pseudo home address to the mobile terminal device;
a unit adapted to receive an IP packet from the correspondent terminal of the mobile terminal device in which an address of a correspondent terminal is a source address and the address for identifier concealment of the mobile terminal device is a determination address;
a unit adapted to create an encapsulated packet in which the received IP packet is encapsulated where an address of the server apparatus is a source address and the care-of address or the actual home address of the mobile terminal device is a determination address; and
a unit adapted to send the created encapsulated packet.

13. A mobile terminal device allowing packet transfer processing according to Mobile IPv6 protocols, the mobile terminal device comprising:
a unit adapted to acquire an address for location concealment to be used as a pseudo care-of address from a server apparatus for providing a service to conceal a care-of address acquired by the mobile terminal device at its present location;
a unit adapted to create an encapsulated packet in which an IP packet containing the acquired address for location concealment as a source address, an address of a correspondent terminal as a determination address and an actual home address of the mobile terminal device is encapsulated where the care-of address of the mobile terminal device is a source address and an address of the server apparatus is a determination address; and
a unit adapted to send the created encapsulated packet.

14. A mobile terminal device allowing packet transfer processing according to Mobile IPv6 protocols, the mobile terminal device comprising:
a unit adapted to acquire an address for location concealment to be used as a pseudo care-of address from a first server apparatus for providing a service to conceal a care-of address acquired by the mobile terminal device at its present location;
a unit adapted to acquire an address for identifier concealment to be used as a pseudo home address from a second server apparatus for providing a service to conceal a home address actually held by the mobile terminal device;
a unit adapted to create an encapsulated packet in which an IP packet containing the acquired address for location concealment as a source address, an address of a correspondent terminal as a determination address and the address for identifier concealment as the home address of the mobile terminal device is encapsulated where an actual care-of address of the mobile terminal device is a source address and an address of the first server apparatus is a determination address; and
a unit adapted to send the created encapsulated packet.

15. A mobile terminal device allowing packet transfer processing according to Mobile IPv6 protocols, the mobile terminal device comprising:
a unit adapted to acquire an address for identifier concealment to be used as a pseudo home address from a server apparatus for providing a service to conceal a home address actually held by the mobile terminal device;
a unit adapted to create an IP packet containing a care-of address acquired by the mobile terminal device at its present location as a source address, an address of a correspondent terminal as a determination address and the address for identifier concealment as a home address of the mobile terminal device; and
a unit adapted to send the created IP packet.

16. A mobile terminal device allowing packet transfer processing according to Mobile IPv6 protocols, the mobile terminal device comprising:
a processor;
a memory connected to the processor; and
a program recorded in the memory,
wherein the program includes:
a function of acquiring an address for location concealment to be used as a pseudo care-of address from a server apparatus for providing a service to conceal a care-of address acquired by the mobile terminal device at its present location;
a function of creating an encapsulated packet in which an IP packet containing the acquired address for location concealment as a source address, an address of a correspondent terminal as a determination address and an actual home address of the mobile terminal device is encapsulated where a care-of address of the mobile terminal device is a source address and an address of the server apparatus is a determination address; and
a function of sending the created encapsulated packet.

17. A mobile terminal device allowing packet transfer processing according to Mobile IPv6 protocols, the mobile terminal device comprising:
a processor;
a memory connected to the processor; and
a program recorded in the memory,
wherein the program includes:
a function of acquiring an address for location concealment to be used as a pseudo care-of address from a first server apparatus for providing a service to conceal a care-of address acquired by the mobile terminal device at its present location;
a function of acquiring an address for identifier concealment to be used as a pseudo home address from a second server apparatus for providing a service to conceal a home address actually held by the mobile terminal device;
a function of creating an encapsulated packet in which an IP packet containing the acquired address for location concealment as a source address, an address of a correspondent terminal as a determination address and the an address for identifier concealment as a home address of the mobile terminal device is encapsulated where the actual care-of address of the mobile terminal device is a source address and an address of the first server apparatus is a determination address; and
a function of sending the created encapsulated packet.

18. A mobile terminal device allowing packet transfer processing according to Mobile IPv6 protocols, the mobile terminal device comprising:
a processor;
a memory connected to the processor; and
a program recorded in the memory,
wherein the program includes:
a function of acquiring an address for identifier concealment to be used as a pseudo home address from a server apparatus for providing a service to conceal a home address actually held by the mobile terminal device;
a function of creating an IP packet containing a care-of address acquired by the mobile terminal device at its present location as a source address, an address of a correspondent terminal as a determination address and the address for identifier concealment as a home address of the mobile terminal device; and
a function of sending the created IP packet.
